(19) United States
(12) Patent Application Publication
(10) Pub. No.: US 2009/0061172 A1
(43) Pub. Date: Mar. 5, 2009

(54) Polyurethane Resin Composition for Durable Moisture-Permeable Waterproof Sheet, Moisture-Permeable Waterproof Sheet and Method of Manufacturing the Same

(75) Inventors: Yutaka Hayashi, Hakusan-shi (JP); Junsho Kanenori, Hakusan-shi (JP); Yukichi Izumi, Nomi-shi (JP); Yoshio Kobayashi, Hikone-shi (JP); Hiroyuki Ogawa, Moriyama-shi (JP)

Correspondence Address: Nixon Peabody LLP, 200 Page Mill Road, Palo Alto, CA, 94306, US

(73) Assignees: KOMATSU SEIREN CO., LTD., Nomi-city (JP); SANYO CHEMICAL INDUSTRIES, LTD., Kyoto-shi (JP)

(21) Appl. No.: 12/162,124

(22) PCT Filed: Jan. 26, 2006
(86) PCT No.: PCT/JP2006/301246

§ 371 Date: Jul. 24, 2008

(51) Int. Cl. B32B 3/10; B32B 5/22; B05D 5/00; B32B 37/12; B05D 3/02; B32B 27/06

(52) U.S. Cl. 428/196; 442/76; 428/319.3; 428/195.1; 427/243; 427/389.9; 156/230

(57) ABSTRACT

Provided is a urethane resin composition for a moisture-permeable waterproof sheet which has excellent moisture permeability, waterproofness, chemical-resistance to insecticide, an organic solvent, etc., and superior durability, a moisture-permeable waterproof sheet, and a method of manufacturing the same. The polyurethane resin composition for a moisture-permeable waterproof sheet includes a hydrophilic polyurethane resin (A), organic polyisocyanate (B) having polyisocyanate (B0) with a functional number of 3 or more, and an organic solvent (C). Further, the hydrophilic polyurethane resin (A) includes high-molecular diol (d) having an oxyethylene group, organic diisocyanate (e), and a chain extender (f), and a content of an oxyethylene group is preferably 10 to 80 mass %. Also, the organic polyisocyanate (B) is at least one selected from the group consisting of aliphatic polyisocyanate and alicyclic polyisocyanate which have an average functional number of from 2.3 to 5.

### CROSS REFERENCE TO RELATED APPLICATIONS OR PRIORITY CLAIM

This application is a national phase of International Application No. PCT/JP2006/301246, entitled “POLYURETHANE RESIN COMPOSITION FOR DURABLE MOISTURE-PERMEABLE WATERPROOF SHEET, MOISTURE-PERMEABLE WATERPROOF SHEET AND METHOD OF MANUFACTURING THE SAME”, which was filed on Jan. 26, 2006, and which claims priority of Japanese Patent Application No. 2004-355834, filed Dec. 8, 2004.

### DESCRIPTION

1. Technical Field

The present invention relates to a polyurethane resin composition for a durable moisture-permeable waterproof sheet, a moisture-permeable waterproof sheet and a method of manufacturing the same.

2. Background Art

In the past, as a moisture-permeable waterproof sheet, a microporous film which is produced by stretching a polytetrafluoroethylene resin, or which is formed by applying a polyurethane resin to a fiber cloth and being subjected to a wet coagulation is used (for example, please see Patent Document 1).

However, the microporous film has a problem in that moisture, dirt etc., causes blocking and thereby reduces its moisture permeability.

Accordingly, a non-porous sheet that is coated with a moisture-permeable polyurethane resin having a hydrophilic property has been proposed. The moisture-permeable polyurethane resin includes, in the polyurethane resin, a polyol component such as a block copolymer of polyoxyethylene and polyoxypropylene, or polyoxyethylene glycol which is a hydrophilic segment.

A non-porous sheet employing the aforementioned moisture-permeable polyurethane resin can be manufactured by a dry method and generally has a three-layer constitution including a fiber cloth, a surface layer of the fiber cloth, and an intermediate bonding layer disposed therebetween. As a resin useful for the surface layer and the intermediate bonding layer, a moisture-permeable thermoplastic urethane resin is often used for the surface layer, and a thermosetting urethane resin is often used for the intermediate bonding layer. A general manufacturing method includes; first applying a urethane resin for a surface layer to a release paper and then drying the coating; subsequently applying a urethane resin for an intermediate bonding layer to a surface of the resin, drying, and then bonding to a fiber cloth; and thereafter removing the release paper, so as to obtain a non-porous sheet (for example, please see Patent Document 2 and Patent Document 3).

Patent Document 1: Japanese Patent Application Publication No. S56-26076

Patent Document 2: Japanese Patent Application Publication No. S64-62320

Patent Document 3: Japanese Patent Application Publication No. H03-203920

### DISCLOSURE OF THE INVENTION

A moisture-permeable waterproof sheet is required to have a variety of capabilities such as moisture permeability, waterproofness, toughness, surface smoothness and chemicals resistance depending on the purpose of use. Here, moisture permeability and waterproofness are properties contradictory to each other. Generally, waterproofness is lowered as moisture permeability is enhanced, while moisture permeability is lowered as waterproofness is enhanced. For example, a microporous sheet considerably improves in moisture permeability by increasing the size of a pore, adopting a sheet having a high porosity, or forming a polyurethane resin film thin, whereas waterproofness is reduced since water can easily pass through the sheet. Alternatively, a microporous sheet improves in waterproofness by decreasing the size of a pore, adopting a sheet having a low porosity, or forming a polyurethane resin film thick, whereas moisture permeability is reduced. Thus, moisture permeability and waterproofness may not be compatible in the non-porous sheet, but a sheet excellent in both moisture permeability and waterproofness is required by users.

Further, a known moisture-permeable waterproof sheet employing a urethane resin is, for example, used for outdoor or military clothes, caps, jackets, and shoes. Here, insecticide or the like may be used to kill or evade harmful insects such as mosquitoes, flies, fleas, and house ticks. The insecticide generally includes N,N′-diethyl-m-toluamides (DEET) or the like as a main ingredient, and thus DEET has a similar chemical structure to dimethylformamide (DMF). Dimethylformamide is generally used as a solvent for a polyurethane resin and has the capability to dissolve the surface layer of the polyurethane resin. Likewise, if DEET having a similar chemical structure to DMF comes in contact with or is employed for the conventional moisture-permeable waterproof sheet, the surface layer of the polyurethane resin is dissolved and damaged, so that waterproofness remarkably decreases. In addition, when DEET contacts with or is used for a low-grade alcohol contained in cosmetics or the like, the surface layer of the polyurethane resin is frequently damaged. Accordingly, durability to chemicals such as insecticide, organic solvents, and cosmetics, has been demanded.

Accordingly, an object of the present invention is to provide a urethane resin composition for a moisture-permeable waterproof sheet which has excellent moisture permeability and waterproofness, chemical-resistance to chemicals such as insecticide, organic solvent, and superior durability, a moisture-permeable waterproof sheet, and a method of manufacturing the same.

The present inventors have conducted extensive studies to solve the above-mentioned problems, and as a result, they have found that aforementioned problems can be solved by employing a polyurethane resin composition including a hydrophilic polyurethane resin, organic polyisocyanate and an organic solvent, and thus completed the present invention.

The present invention employs the following configuration to accomplish the foregoing object.

The present invention relates to a polyurethane resin composition for a moisture-permeable waterproof sheet including a hydrophilic polyurethane resin (A), organic polyisocyanate (B) having polyisocyanate (B0) with a functional number of 3 or more, and an organic solvent (C).

Further, the hydrophilic polyurethane resin (A) is a polyurethane resin including high-molecular diol (d) containing an oxyethylene group, organic diisocyanate (e), and a chain extender (f), and the content of the oxyethylene group is preferably 10 to 80 mass % with respect to the hydrophilic polyurethane resin (A).

Also, the organic polyisocyanate (B) is preferably at least one selected from the group consisting of aliphatic polyisocyanate and alicyclic polyisocyanate which have an average functional number of from 2.3 to 5.

The moisture-permeable waterproof sheet of the present invention is characterized by including a non-porous layer of a polyurethane resin formed by reacting the polyurethane resin composition, and at least one of fiber cloth and an open successive porous film.

The non-porous layer is preferably the outermost layer or a neighboring layer to the outermost layer.

Here, the outermost layer refers to a surface layer of the moisture-permeable waterproof sheet, where the side comes in contact with raindrops or chemicals, and the neighboring layer refers to an adjacent layer or a layer coming next to the outermost layer.

Further, a pattern may be formed on the non-porous layer by a resin film formed by reacting the polyurethane resin composition. For example, a variety of patterns such as a spot, line, lattice, diamond, star, and butterfly may be formed on the non-porous layer using a resin film formed by a reaction of the polyurethane composition.

Also, the open successive porous film is preferably a successive porous polytetrafluoroethylene film.

The moisture-permeable waterproof sheet of the present invention is preferably 5,000 mmH₂O or more in water resistance of JIS L 1092 after treatment with an organic solvent including at least one selected from N,N′-diethyl-m-toluamides and amide-based solvents.

Here, the treatment with the organic solvent refers to a treatment including: lightly rubbing the surface of the non-porous film of the obtained moisture-permeable sheet (and a pattern in case the pattern is formed on the non-porous film) once with a sanitary cotton with an organic solvent containing at least one selected from the group consisting of N,N′-diethyl-m-toluamides (DEET) and amide-based solvents and drying for two minutes, and repeating this operation 20 times.

Here, the amide-based solvents include, for example, dimethylformamide, dimethylacetamide.

The present invention further relates to a method of manufacturing a moisture-permeable waterproof sheet which forms a non-porous layer by applying and drying a polyurethane resin composition which includes a hydrophilic polyurethane resin (A), an organic polyisocyanate (B) having a polyisocyanate (B0) having a functional number of 3 or more, and an organic solvent (C) and has a viscosity of 1,000 to 30,000 mPa·s on at least one side of a fiber cloth and open successive porous film.

Also, it is preferable to form a non-porous layer by bonding fiber cloth to one side of the open successive porous film and applying and drying the polyurethane resin composition with a viscosity of 1,000 to 30,000 mPa·s on the other side of the open successive porous film.

The present invention further relates to another method of manufacturing a moisture-permeable waterproof sheet, which includes applying a coating solution prepared from a polyurethane resin composition including a hydrophilic polyurethane resin (A), organic polyisocyanate (B) having polyisocyanate (B0) with a functional number of 3 or more, and an organic solvent (C) on a release paper and drying the coating to form a non-porous film, providing a binder resin on the non-porous film to bond the non-porous film with fiber cloth and/or a successive porous film through a binder resin, and eliminating the release paper.

Further, in the manufacturing method, the open successive porous film is a successive porous polytetrafluoroethylene film.

According to the present invention, it is possible to provide a urethane resin composition for a moisture-permeable waterproof sheet which has excellent moisture permeability and waterproofness, chemical-resistance to chemicals such as insecticide, an organic solvent, and superior durability. Also, the present invention provides a moisture-permeable waterproof sheet employing the urethane resin composition and a method of manufacturing the same.

### BEST MODE FOR CARRYING OUT THE INVENTION

### <<Configuration of Sheet>>

A moisture-permeable waterproof sheet according to the present invention includes a non-porous layer of a polyurethane resin formed of a specific polyurethane resin composition. Further, the sheet is formed by laminating the non-porous layer, a fiber cloth and/or an open successive porous film.

### <Polyurethane Resin Composition>

Here, the polyurethane resin composition includes a hydrophilic polyurethane resin (A), organic polyisocyanate (B) having polyisocyanate (B0) having a functional number of 3 or more, and an organic solvent (C).

### [Hydrophilic Polyurethane Resin (A)]

The hydrophilic polyurethane resin (A) according to the present invention is a polyurethane resin including high-molecular diol, organic diisocyanate (e), and a chain extender (f).

As a high-molecular diol, among others, a high-molecular diol (d) containing an oxyethylene group is preferable. The high-molecular diol (d) containing an oxyethylene group, for example, includes polyoxyethylene glycol, (hereinafter, abbreviated to a “PEG”), poly(oxyethylene-oxypropylene) block copolymer diol, poly(oxyethylene-oxytetramethylene) block copolymer diol, random ethylene oxide-propylene oxide copolymer diol, random ethylene oxide-tetrahydrofuran copolymer diol; ethylene oxide adducts of low-molecular glycol such as ethylene glycol, propylene glycol, 1,4-butanediol, 1,6-hexamethylene glycol, bis(hydroxymethyl)cyclohexane, and 4,4′-bis(2-hydroxyethoxy)-diphenylpropane; condensed polyether-ester diol obtained by reacting PEG having a molecular weight of 1,000 or less with dicarboxylic acids (for example, succinic acid, adipic acid, sebacic acid, terephthalic acid, and isophthalic acid); and a mixture of two or more kinds thereof. Among them, PEG, poly(oxyethylene-oxypropylene) block copolymer diol, and poly(oxyethylene-oxytetramethylene) block copolymer diol are preferable, and PEG is particularly preferable.

The content of the oxyethylene group in the high-molecular diol (d) containing the oxyethylene group is preferably at least 40 mass % and more preferably at least 50 mass %, in view of moisture permeability. The molecular weight of (d) is preferably from 700 to 20,000 and more preferably from 1,000 to 15,000.

Further, the diol may be used with another high-molecular diol (d1) as long as the moisture permeability is not hindered. (d1) is generally 0 to 60 mass % and preferably 10 to 50 mass % based on the mass of (d).

The high-molecular diol (d1) includes polyether diol (α), polyester diol (β), polycarbonate diol (χ), a mixture thereof and the like. High-molecular diol with a molecular weight of generally 600 to 5,000 is used.

The polyether diol (α) includes diol not containing an oxyethylene group, for example, polyoxypropylene glycol, polyoxytetramethylene glycol (hereinafter, abbreviated to “PTMG”), poly(oxypropylene-oxytetramethylene) block copolymer diol, and a mixture of two or more kinds thereof.

The polyester diol (β) includes condensed polyester diol obtained by reacting low-molecular diol and/or polyether diol with a molecular weight of 1,000 or less with dicarboxylic acids, polylactone diol obtained by the ring-opening polymerization of lactone, and the like.

The low-molecular diol includes low-molecular glycol mentioned above as the high-molecular diol containing the oxyethylene group.

Polyether diol with a molecular weight of 1,000 or less includes polypropylene glycol, PTMG, etc.

Dicarboxylic acids includes aliphatic dicarboxylic acids (for example, succinic acid, adipic acid, and sebacic acid), aromatic dicarboxylic acids (terephthalic acid, isophthalic acid, etc.), and a mixture of two or more kinds thereof.

Lactone, for example, includes ε-carprolactone.

Specific examples of the polyester diol (β) are polyethylene adipate, polybutylene adipate, poly 2,2-dimethyltrimethylene adipate, poly 3-methylpentamethylene adipate, polyhexamethylene adipate, polycaprolactone diol, and a mixture of two or more kinds thereof.

The polycarbonate diol (χ), for example, includes poly(hexamethylene carbonate) diol.

The organic diisocyanate (e) used for the hydrophilic polyurethane resin of the present invention, for example, includes (1) aliphatic diisiocyanate having 6 to 12 carbon atoms [except carbon in an NCO group, also corresponding to the following (2) to (4)], (2) alicyclic diisocyanate having 6 to 15 carbon atoms, (3) aromatic-aliphatic diisocyanate having 8 to 12 carbon atoms, (4) aromatic diisocyanate having 6 to 30 carbon atoms, and a mixture of two or more kinds thereof.

Specific examples of the aliphatic diisocyanate (1) include hexamethylene diisocyanate (HDI), dodecamethylene diisocyanate, 2,2,4-trimethylhexamethylene diisocyanate, lysine diisocyanate, 1,3,6-trimethylhexamethylene diisocyanate, etc.

Specific examples of the alicyclic diisocyanate (2) include isophorone diisocyanate (IPDI), dicyclohexylmethane-4,4′-diisocyanate (hydrogenated MDI), 1,4-cyclohexane diisocyanate, methylcyclohexane-2,4-diisocyanate (hydrogenated TDI), 1,4-bis(2-isocyanatoethyl)cyclohexane, etc.

Specific examples of the aromatic-aliphatic diisocyanate (3) include p- or m-xylylene diisocyanate, α,α,α′, α′-tetramethylxylylene diisocyanate, etc.

Specific examples of the aromatic diisocyanate (4) include 1,3- or 1,4-phenylene diisocyanate, 2,4- or 2,6-trilene diisocyanate (TDI), 2,4′- or 4,4′-diphenylmethane diisocyanate (MDI), naphthalene-1,5-diisocyanate, 3,3′-dimethyldiphenylmethane-4,4′-diisocyanate, etc. Among them, the aromatic diisocyanate is preferable, wherein MDI is more preferable.

The chain extender (f), for example, includes low-molecular diol [ethylene glycol (hereinafter, abbreviated to “EG”), propylene glycol, 1,4-butanediol (hereinafter, abbreviated to “BG”), etc.], aliphatic diamines (ethylene diamine, etc.), alicyclic diamines (isophorone diamine, 4,4′-diaminodicyclohexylmethane, etc.), aromatic diamines (4,4′-diaminodiphenylmethane, etc.), alkanolamines (ethanolamine, etc.), hydrazine, and a mixture of two or more kinds. Preferably, the chain extender (f) is the low-molecular diol.

The content of an oxyethylene group in the hydrophilic polyurethane resin (A) is preferably 10 mass % or more, more preferably 20 mass % or more, and even more preferably 25 mass % or more with respect to (A) in view of moisture permeability. Also, it is preferably 80 mass % or less, more preferably 70 mass % or less, and even more preferably 65 mass % or less in view of the strength of a film.

In the hydrophilic polyurethane resin (A), a ratio of the organic diisocyanate to the high-molecular diol and the chain extender (the equivalent ratio of NCO:OH+NH) is generally (0.95 to 1.05):1 and preferably and practically 1:1. If the equivalent ratio of NCO/OH+NH is within the range, the polyurethane resin has a high molecular weight, thereby preparing a polyurethane resin having useful properties for applications. The molecular weight of the hydrophilic polyurethane resin (d) is the number average molecular weight which is preferably 5,000 to 300,000 and more preferably 8,000 to 200,000.

The hydrophilic polyurethane resin (A) preferably has an end group of OH in order to react with organic polyisocyanate (B) to give a polyurethane resin having chemical resistance. For the concentration of the end group, a hydroxyl value is preferably from 0.5 to 25, more preferably from 1 to 20, and even more preferably from 1.5 to 15 as the solid content of (A).

An organic solvent suitable for the case of preparing the hydrophilic polyurethane resin (A) in the presence of a solvent, for example, includes amide-based solvents (DMF, dimethylacetamide, etc.), sulfoxide-based solvents (dimethylsulfoxide, etc.), ketone-based solvents (methyl ethyl ketone (MEK), etc.), aromatic solvents, (toluene, xylene, etc.), ether-based solvents (dioxane, tetrahydrofuran, etc.), ester-based solvents (acetic acid ethyl, acetic acid butyl, etc.), and a mixture of two or more kinds thereof. Among them, amide-based solvents, ketone-based solvents, aromatic solvents, and a mixture of two or more kinds thereof are preferable.

An amount of the organic solvent is an amount for the concentration of a solid part of the polyurethane resin to be generally from 5 to 50 mass % and preferably from 10 to 40 mass %.

In manufacturing the hydrophilic polyurethane resin (A), a reaction temperature may be the same temperature generally adopted in the polyurethane polymerization. Generally, the temperature is 20 to 100° C. under a solvent and 20 to 220° C. without a solvent.

As necessary, catalysts [for example, amine-based catalysts (triethyl amine, triethylene diamine, etc.), and tin-based catalysts (dibutyltin dilaurate, etc.)] generally used for the polyurethane polymerization may be employed to promote the reaction.

Further, a polymerization stopper [for example, monovalent alcohols (ethanol, butanol, etc.), monovalent amines (diethyl amine, dibutyl amine, etc.), low-molecular diol (EG, BG, etc.), alkanolamines (ethanolamine, diethanol amine, etc.), etc.] may be used if necessary.

The hydrophilic polyurethane resin (A) may be prepared by equipment generally employed in the art. Also, a kneader, extruder, or the like may be used when a solvent is not used. The polyurethane resin prepared as above has a solution viscosity of generally 1 to 1,000 Pa·s/20° C., which is measured with 30 mass % (solid part) DMF solution, and preferably 5 to 200 Pa·s/20° C. for practical uses.

### [Organic Polyisocyanate (B)]

The organic polyisocyanate (B) in the present invention contains polyisocyanate (B0) having a functional number of 3 or more. Besides, it may contain organic diisocyanate (e). In the case that (B) contains only (e) having a functional number of 2, durability to DEET or the like is not sufficient. The average functional number of (B) is preferably 2.3 to 5 and more preferably 2.5 to 5 with respect to durability to DEET.

The polyisocyanate (B0) having a functional number of 3 or more, for example, includes an urethane variant obtained by reacting the organic diisocyanate (e) (3M) and trimethylolpropane (TMP) (1M) (for example, a variant from the reaction of HDI, IPDI, or TDI and TMP, etc.), a burette variant obtained by reacting (e) (3M) and water (1M) (for example, a variant from the reaction of HDI or IPDI and water, etc.), an isocyanurate variant of (e) (for example, a trimer of HDI, IPDI, or TDI, etc.), dimers of the aforementioned variants (for example, a variant from the reaction of the urethane variant, burette variant, or isocyanurate variant (2M) and water or EG (1M), etc.), trimers of the aforementioned variants (for example, a variant from the reaction of the urethane variant, burette variant, or isocyanurate variant (3M) and water or EQ (2M), etc.), and a mixture of two or more kinds thereof. Among them, aliphatic polyisocyanate which is the variant employing aliphatic diisocyanate, alicyclic polyisocyanate which is the variant employing alicyclic diisocyanate, and a mixture of two or more kinds thereof are preferable, and aliphatic polyisocyanate of the isocyanurate variant, alicyclic polyisocyanate of the isocyanurate variant, and a mixture of two or more kinds thereof are more preferable. In particular, an isocyanurate variant of HDI, an isocyanurate variant of IPDI, and a mixture thereof are exemplary.

The mass ratio of the polyisocyanate (B0) having a functional number of 3 or more and the organic diisocyanate (e), (B0):(e), is preferably 50:50 to 100:0, and more preferably 60:40 to 100:0.

In the present invention, for a ratio of the organic polyisocyanate (B) to the hydrophilic polyurethane resin (A), the organic polyisocyanate is used in a ratio of preferably 3 to 60 parts by mass, more preferably 10 to 50 parts by mass, and even more preferably 15 to 35 parts by mass, with respect to 100 parts by mass of the hydrophilic polyurethane resin (as a solid part). If the ratio is 3 parts by mass or more, the durability to DEET or the like is sufficient. If the ratio is 60 parts by mass or less, the texture is not too hard.

### [Organic Solvent (C)]

For the organic solvent (C) in the present invention, those exemplified for a suitable organic solvent upon manufacturing the hydrophilic polyurethane resin (A) can be used. Among them, amide-based solvents, ketone-based solvents, aromatic solvents, and a mixture of two or more kinds thereof are preferable.

An amount of the organic solvent (C) is an amount for the concentration of the resin solid part in the polyurethane resin to be generally 5 to 50 mass % and preferably 10 to 40 mass %.

### [Other Additives]

The polyurethane resin of the present invention may contain various stabilizers, coloring agents, inorganic fillers, and organic reforming agents for the improvement of weatherability, heat-deterioration resistance, etc., an infiltration enhancer for the improvement of bonding strength to a porous film, and other additives. When various fillers and cross-linkers are added, the polyurethane resin layer may also be designed to control the thickness and the like.

Further, the polyurethane resin, polyisocyanate, and other additives may be mixed by only stirring generally used or using mixing equipment (ball mill, kneader, sand grist, roll mill, etc.).

In the case where a polyurethane resin with a great number of oxyethylene groups is used among the hydrophilic polyurethane resins of the present invention, when water is adhered to the surface of the obtained non-porous film, the film may absorb the water to expand. It is effective to mix a polyurethane resin having a great average content of oxyethylene groups and one having a small content of oxyethylene groups or a non-hydrophilic polyurethane resin in view of the control of the expansion.

### <Fiber Cloth>

Fiber cloth, for example, includes all kinds of fabric such as a natural fiber, and synthetic fiber. In detail, cotton, staple fiber, polyester, nylon, acryl, and a mixed fabric of two or more thereof may be used. As for a type, woven, knitted, nonwoven, and fluffed fabric can be used. Also, a laminated material in which a porous film of a polyurethane resin is formed on one side of a fiber cloth may be used. The fiber cloth may be durable-water-repellently treated with a silicon resin, a fluorine resin or the like, in order to prevent excessive infiltration.

### <Open Successive Porous Film>

Open successive porous film (hereinafter, abbreviated to a “successive porous film”) refers to a film having a great number of successive pores leading from one surface to the other surface, which is, for example, described in U.S. Pat. No. 3,953,566 and No. 4,187,390. In detail, Gore-Tex (registered trademark) sold by W. L. Gore & Associates, Inc., PTFE membranes such as Tetratex (registered trademark) sold by Nippon Donaldson Limited, microporous films sold by Sumitomo 3M Ltd., polypropylene films such as Tyvek (registered trademark) sold by Dupont. Among them, the PTFE membranes are preferable, and a stretching type is more preferable in view of readily increasing the porosity, while the porosity is preferably 80% or more. If using the PTFE membrane, a hydrophilic polyurethane resin solution is not dissolved in an organic solvent such as dimethylformamide when it is applied to be impregnated. Thus, the hydrophilic polyurethane resin can be impregnated in the successive minute pores to facilitate easy the formation of a non-porous layer.

If the thickness of the successive porous film is less than 6 μm, sufficient waterproofness and strength can not be obtained. If the thickness is more than 200 μm, sufficient moisture permeability can not be obtained.

### <Properties of Sheet>

The moisture-permeable waterproof sheet of the present invention has excellent moisture permeability, waterproofness, and chemicals resistance to chemicals such as insecticide, and an organic solvent.

Hereinafter, the properties of the sheet will be described in detail.

### [Moisture Permeability]

Here, moisture permeability is measured by a potassium acetate method of JIS L 1099 (testing methods for moisture permeability of textile products).

The moisture permeability of the sheet is preferably 5,000 g/(m²·24 hours) or more, more preferably 7,000 g/(m²·24 hours), and even more preferably 10,000 g/(m²·24 hours) or more. If the moisture permeability is 5,000 g/(m²·24 hours) or more, the reduction in humidity is improved to expand applications.

### [Waterproofness]

Here, waterproofness refers to water resistance measured by JIS L 1092 (a high water pressure method for testing water resistance of textile products).

The water resistance of the sheet is preferably 5,000 mmH₂O or more, more preferably 7,000 mmH₂O or more, and even more preferably 10,000 mmH₂O or more. If the water resistance is 5,000 mmH₂O or more, the sheet can be sustainable under a heavy rain to expand applications.

### [Chemicals Resistance]

Here, chemicals resistance is represented by water resistance measured after treatment with an organic solvent.

The treatment with the organic solvent refers to a treatment including the following: lightly rubbing the surface of the non-porous film of the obtained moisture-permeable waterproof sheet (and a pattern in the case the pattern is formed on the non-porous film) once with a sanitary cotton with an organic solvent containing at least one selected from the group consisting of DEET and amide-based solvents (DMF, dimethylacetamide, etc.) and drying for two minutes, and then this operation is repeated 20 times.

If the water resistance is not considerably decreased by the foregoing treatment, and is 5,000 mmH₂O or more, the sheet has excellent chemicals resistance and durability to insecticides or the like even being sprayed and expands its applications as a high-performance moisture-permeable waterproof sheet.

### <<Manufacturing Method of Moisture-Permeable Waterproof Sheet>>

In the following, a method of manufacturing the moisture-permeable waterproof sheet of the present invention will be described.

The moisture-permeable waterproof sheet according to the present invention may be manufactured by a general method. There are direct coating that the non-porous layer is coated on the open successive porous film, dry laminating that the non-porous film is formed on a release paper, applied with a bonding agent to be bonded to the open successive porous film and/or fiber cloth, dried, and released from the release paper, etc.

### <Non-Porous Layer>

The viscosity of the polyurethane resin composition (B-type viscometer, rotor number 4, and 12 rpm) is adjusted to preferably 1,000 to 30,000 mPa·s and more preferably 1,500 to 6,000 mPa·s. If the viscosity is 1000 to 30,000 mPa·s, applicability and manufacturing efficiency are excellent.

A method of the non-porous layer of a polyurethane resin from the polyurethane resin composition is as follows: a coating solution is prepared from the hydrophilic polyurethane resin composition to be applied on a release paper or the porous film, dried by a drier of 50 to 150° C., and allowed aging at 30 to 100° C. for 20 to 72 hours.

The non-porous layer in the moisture-permeable waterproof sheet of the present invention is preferably provided as an outermost layer or a layer near thereto, for the purpose of effectively exhibiting waterproof property and chemical resistance.

Here, the outermost layer refers to the surface layer of the moisture-permeable waterproof sheet, where is the side coming in contact with raindrops or chemicals, and the neighboring layer refers to an adjacent layer or a layer coming next to the outermost layer.

### <Non-Porous Layer/Fiber Cloth>

The coating solution prepared from the polyurethane resin composition is applied on a release paper by a knife coater, a pipe coater, and a bar coater and dried to form the non-porous layer. Then, a binder resin is arbitrarily provided entirely, linearly, or in spots on the non-porous layer by a gravia coater or the like. The fiber cloth, processed by refining, dying, water-repelling, etc. as necessary, is bonded to the surface where the binder resin is provided and allowed to aging (at 30 to 100° c. for 20 to 72 hours) if necessary, and then the release paper is removed to obtain the sheet according to a dry laminating method.

### <Non-Porous Layer/Successive Porous Film>

The coating solution prepared from the polyurethane resin composition may be applied on the successive porous layer by direct coating or the like. Coating, for example, may be carried out with a gravia coater, a knife coater, a die coater, a pipe coater, a bar coater, a pad coater, etc, and preferably with a pipe coater or a bar coater in view of the impregnation of the coating solution prepared from the polyurethane resin composition to the successive porous film.

Further, a non-porous layer prepared of a film type in advance may be bonded to the successive porous film with a bonding agent or the like by heat press at 80 to 140° C. and 10 to 500 kPa.

### <Non-Porous Layer/Successive Porous Film/Fiber Cloth>

In the case of the moisture-permeable waterproof sheet having a fiber cloth on one side, a binder resin is provided entirely, linearly, or in spots on the successive porous film by a gravia coater or the like. The fiber cloth, processed by refining, dying, water-repelling, etc. as necessary, is bonded to the side where the binder resin is provided. Then, aging (at 30 to 100° C. for 20 to 72 hours) is carried out as necessary.

Thereafter, the coating solution prepared from the polyurethane resin composition is applied on the other surface of the successive porous film, where a fiber cloth is not bonded and dried, thereby forming the non-porous layer.

Alternatively, a successive porous film with a non-porous layer formed in advance may be bonded to a fabric cloth by the same process. In addition, a successive porous film may be bonded to a non-porous layer using the foregoing dry laminating to form the non-porous layer on the successive porous film.

### <Fiber Cloth/Non-Porous Layer/Successive Porous Film/Fiber Cloth>

In the case where the moisture-permeable waterproof sheet has a fiber cloth on both sides, a binder resin is provided entirely, linearly, or in spots on a surface of the non-porous layer of the successive porous film by a gravia coater or the like, the successive porous film having a non-porous layer formed on one side and a fiber cloth bonded to the other side. The fiber cloth, processed in advance by various works such as refining, dying, water-repelling, as necessary, is bonded to the side where the binder resin is provided. Then, drying and aging may be carried out if necessary and further water-repellency processing may be conducted as necessary, thereby producing the moisture-permeable waterproof sheet.

The moisture-permeable waterproof sheet obtained by the foregoing method has excellent moisture permeability and waterproofness and provides agreeable working (exercising) conditions. Thus, its capabilities are not easily degraded while contacting with or being used for insecticide or the like, so that it can suitably be used for outdoor or military clothes, capas, jackets, shoes, etc. by coloring a polyurethane layer for the improvement of a design.

Also, as the organic solvents such as dimethylformamide, dimethylacetamide, etc. have durability to contact and use, the sheet can be used for special working clothes (chemicals protective clothes, etc.) and filters to provide good working conditions or equipment.

Further, it is preferable that a pattern is given on the non-porous layer by a resin film formed by reacting the polyurethane resin composition of the present invention.

For example, a variety of patterns such as a spot, line, lattice, diamond, star, butterfly, etc. may be formed on the non-porous layer using a resin obtained by reacting the polyurethane resin composition of the present invention. The reason why the pattern is formed is described in the following. That is, as for the use of clothes without a lining:
1. A pattern is formed on a layer to have a design.
2. Angular organic or inorganic particles are mixed with a resin of forming a pattern so as to provide a dry touch (sense) on a layer.
3. Spherical organic or inorganic particles are mixed with a resin of forming a pattern so as to provide a smooth touch (sense) on a layer.

In addition, the resin to form a pattern of the present invention has durability to N,N′-diethyl-m-toluamides and amide-based solvents, and thus a pattern formed is not removed by an insecticide or the like adhered thereto.

### EXAMPLES

Hereinafter, although examples of the present invention will be illustrated, the present invention will not be limited to the following examples. Further, it should be understood that the terms “part” and “%” refer to part by mass and mass %, respectively, with respect to a solid part excluding water as long as specifically mentioned.

Hydrophilic polyurethane resin composition solutions with different contents of the oxyethylene group (hereinafter, abbreviated to an “OE group) were prepared to manufacture various moisture-permeable waterproof sheets shown in the following examples.

<Preparation of Hydrophilic Polyurethane Resin Solution>(Hydrophilic Polyurethane Resin with OE-Group Content of 50%, A-1)

148.6 parts of PEG with a number average molecular weight of 2,000 (calculated from a hydroxyl value), 26.4 parts of EG; 125 parts of MDI, and 700 parts of DMF were put into a four-opening flask equipped with an agitator and a thermometer and reacted at 70° C. for 7 hours under a dry nitrogen atmosphere. Next, 0.5 parts of EG was added to complete the reaction, thereby preparing a hydrophilic polyurethane resin (A-1) solution with a resin concentration of 30% and a viscosity of 10,000 mPa/20° C. The content of an OE group in A-1 was 50%.

(Hydrophilic Polyurethane Resin with OE-Group Content of 30%; A-2)

89.9 parts of PEG with a number average molecular weight of 2,000, 59.9 parts of polyethylene adipate with a number average molecular weight of 2,000, 34.8 parts of BG, 115.4 parts of MDI, and 700 parts of DMF were put and reacted by the same method used in A-1. Next, 0.5 parts of EG was added to complete the reaction, thereby preparing a hydrophilic polyurethane resin (A-2) solution with a resin concentration of 30% and a viscosity of 9,000 mPa/20° C. The content of an OE group in A-2 was 30%.

(Polyurethane Resin with OE-Group Content of 0%: A-3)

149.8 parts of polyethylene adipate with a number average molecular weight of 2,000, 34.8 parts of BG, 115.4 parts of MDI, and 700 parts of DMF were put and reacted by the same method used in A-1. Next, 0.5 parts of EG was added to complete the reaction, thereby preparing a hydrophilic polyurethane resin (A-3) solution with a resin concentration of 30% and a viscosity of 9,000 mPa/20° C. The content of an OE group in A-3 was 0%.

### Examples 1 to 3 and Comparative Examples 1 and 2

### <Direct Coating>

A moisture-permeable waterproof sheet formed of a non-porous film/PTFE of a resin composition containing each of the foregoing polyurethane resin solutions was manufactured as follows.

### Example 1

A resin composition with a viscosity of 5000 mPa·s specified as follows was directly coated by a pipe coater on one surface of a stretching PTFE membrane (92% in porosity and 38 μm in thickness):

100 parts of A-1, 30 parts of MEK, 10 parts of DMF, 6 parts of Duranate TPA-100 (from Asahi Kasei Corporation, HDI isocyanurate variant having a functional number of 3.0), 0.5 parts of HI-299 (from Dainichiseika Color & Chemicals Mfg Co., Ltd., amine-based catalyst), 10 parts of L7075 (from Dainippon Ink & Chemicals Inc., white pigment), and 0.4 parts of X-22-3701E (from Shin-Etsu Chemical Co., Ltd., infiltration enhancer).

Subsequently, the resultant product was dried at 130° C. for two minutes and aged at 40° C. for 24 hours to form a non-porous layer of 22 g/m², thereby producing a moisture-permeable sheet.

### Example 2

Example 2 was prepared by the same process of Example 1 except for the addition of 4 parts of Duranate TPA-100 (from Asahi Kasei Corporation, HDI isocyanurate variant having a functional number of 3.0) and 2 parts of Duranate D-50 (from Asahi Kasei Corporation, HDI isocyanurate variant having a functional number of 2.0), thereby producing a moisture-permeable waterproof sheet.

### Example 3

Example 3 was prepared by the same process of Example 1 except that A-2 is used instead of A-1, thereby producing a moisture-permeable waterproof sheet.

### Comparative Example 1

Comparative Example 1 was prepared by the same process of Example 1 except that A-3 is used instead of A-1, thereby producing a moisture-permeable waterproof sheet.

### Comparative Example 2

Comparative Example 2 was prepared by the same process of Example 1 except 6 parts of Duranate TPA-100 (from Asahi Kasei Corporation, HDI isocyanurate variant having a functional number of 3.0) and 0.5 parts of HI-299 (from Dainichiseika Color & Chemicals Mfg Co., Ltd., amine-based catalyst) were removed, thereby producing a moisture-permeable waterproof sheet.

### Categories and Methods for Evaluation

The obtained moisture-permeable waterproof sheets were evaluated as follows. Categories and methods of evaluation were explained as follows and result of evaluation was shown in Table 1.

### [Moisture Permeability]

Moisture permeability was evaluated by measuring moisture permeability according to a JIS L 1099 B-1 method (potassium acetate method). Here, a unit was converted per 24 hours (g/(m²·24 hours)).

### [Waterproofness]

Waterproofness was evaluated by measuring a water resistance according to a JIS L 1092 B method (high water pressure method). If a sample was extended by water pressure, nylon taffeta (density: length+width=210 pieces/2.54 equivalent) was put on the sample and measured in a tester.

### [Chemicals Resistance]

Chemicals resistance was evaluated by measuring water resistance (JIS L 1092 B method) as follows: the surface of a non-porous film of the obtained moisture-permeable sheet (and a pattern in the case it was formed on the non-porous film) was lightly rubbed once with a sanitary cotton with an insecticide containing DEET (product name: Cutter OUTDOORSMAN, composition: DEET 21.85%, DEET isomer 1.15%, and other ingredients 77.0%) sold at the US market and dried for two minutes, and this operations was repeated 20 times.

Also, a 50% DMF/50% ethanol solution was used instead of the insecticide for the evaluation.

In addition, a unit was given in terms of water unit used in a JIS L 1092 A method (low water pressure method) thereby expressing in mmH₂O for the convenience of a person skilled in the art in comparison.

TABLE 1

| | Example | Example | Example | Comparative | Comparative |
|---|---|---|---|---|---|
| | 1 | 2 | 3 | Example 1 | Example 2 |
| Polyurethane resin | A-1 | A-1 | A-2 | A-3 | A-1 |
| (OE-group Content) | (50%) | (50%) | (30%) | (0%) | (50%) |
| Average Functional | 3.0 | 2.7 | 3.0 | 3.0 | No cross- |
| number of Cross- | | | | | linker |
| linker | | | | | |
| Moisture | 102000 | 105000 | 91000 | 4300 | 110500 |
| Permeability | | | | | |
| [g/m² · 24 hours] | | | | | |
| Water Resistance | 20,000 | 20,000 | 20,000 | 20,000 | 20,000 |
| [mm H₂O] | or more | or more | or more | or more | or more |
| Water Resistance | 20,000 | 20,000 | 20,000 | 20,000 | 3,600 |
| after Insecticide | or more | or more | or more | or more | |
| Treatment | | | | | |
| [mm H₂O] | | | | | |
| Water Resistance | 20,000 | 20,000 | 20,000 | 20,000 | 1,800 |
| after DMF/Ethanol | or more | or more | or more | or more | |
| Solution Treatment | | | | | |
| [mm H₂O] | | | | | |

### Examples 4 and 5 and Comparative Examples 3 and 4

### <Dry Laminating>

A moisture-permeable waterproof sheet formed of a non-porous film/polyester plain fabric of a resin composition containing each of the foregoing polyurethane resin solutions was manufactured as follows.

### Example 4

A resin composition with a viscosity of 4,000 mPa·s specified as follows was prepared:

100 parts of A-1, 40 parts of MEK, 10 parts of DMF, 8 parts of Duranate TPA-100 (from Asahi Kasei Corporation, HDI isocyanurate variant having a functional number of 3.0), 0.5 parts of HI-299 (from Dainichiseika Color & Chemicals Mfg Co., Ltd., amine-based catalyst), and 10 parts of L7075 (from Dainippon Ink & Chemicals Inc., white pigment).

The resin composition was coated on the entire surface of full-dull release paper (from Lintec Corporation) using a knife overall coater. The resin on the release paper was dried by an air oven at 120° C. to form a non-porous film with a thickness of 10 μm.

Next, a binder resin solution was prepared to have the following composition:

100 parts of Y134-45 (from Dainichiseika Color & Chemicals Mfg Co., Ltd., second liquid-type polyurethane resin, solid part 60%), 30 parts of toluene, 40 parts of MEK, 9 parts of Coronate HL (from Nippon Polyurethane Industry Co., Ltd., isocyanate), and 0.5 parts of HI-299 (from Dainichiseika Color & Chemicals Mfg Co., Ltd., amine-based catalyst).

The resin solution was applied on the non-porous film in spots by a gravia coater and dried at 120° C., after which the polyester plain fabric (83 dtex in both lengthwise and widthwise yarns, 72 filament, lengthwise density×widthwise density: 111 pieces×90 pieces/2.54 cm, weight per unit area: 75 g/m²) was bonded to the non-porous film through the binder resin by heat press at 120° C. and 400 kPa. Then, the resultant product was aged at 40° C. for 24 hours, followed by removing the release paper. Subsequently, the product was treated by water repelling using Asahi Guard AG5690 (from Asahi Glass Co., Ltd., fluorine-based water repellent agent) and finished at 150° C. for 30 seconds, thereby producing a moisture-permeable waterproof sheet.

### Example 5

Example 5 was prepared by the same process of Example 4 except using A-2 instead of A-1, thereby producing a moisture-permeable waterproof sheet.

### Comparative Example 3

Comparative Example 3 was prepared by the same process of Example 4 except using A-3 instead of A-1, thereby producing a moisture-permeable waterproof sheet.

### Comparative Example 4

Comparative Example 4 was prepared by the same process of Example 4 except the elimination of 8 parts of Duranate TPA-100 (from Asahi Kasei Corporation, HDI isocyanurate variant having a functional number of 3.0) and 0.5 parts of HI-299 (from Dainichiseika Color & Chemicals Mfg Co., Ltd., amine-based catalyst), thereby producing a moisture-permeable waterproof sheet.

The evaluation results of the moisture-permeable waterproof sheets obtained in Examples 4 and 5 and Comparative Examples 3 and 4 were illustrated in Table 2.

TABLE 2

| | | | Compara- | Compara- |
|---|---|---|---|---|
| | Example | Example | tive | tive |
| | 4 | 5 | Example 3 | Example 4 |
| Polyurethane Resin | A-1 | A-2 | A-3 | A-1 |
| (OE-group Content) | (50%) | (30%) | (0%) | (50%) |
| Average Functional | 3.0 | 2.7 | 3.0 | No cross- |
| number of Cross- | | | | linker |
| linker | | | | |
| Moisture Permeability | 19,500 | 16,000 | 3,300 | 22,000 |
| [g/m² · 24 hours] | | | | |
| Water Resistance | 20,000 | 20,000 | 20,000 | 20,000 |
| [mm H₂O] | or more | or more | or more | or more |
| Water Resistance after | 20,000 | 20,000 | 20,000 | 3,200 |
| Insecticide Treatment | or more | or more | or more | |
| [mm H₂O] | | | | |

### Example 6 and Comparative Example 5

### Wet and Dry Laminating>

A moisture-permeable waterproof sheet formed of a non-porous film/porous polyurethane resin film/polyester plain fabric of a resin composition containing each of the foregoing polyurethane resin solutions was manufactured as follows.

### Example 6

A resin composition with a viscosity of 4000 mPa·s or less specified as follows was prepared:

100 parts of A-1, 40 parts of MEK, 10 parts of DMF, 6 parts of Duranate TPA-100 (from Asahi Kasei Corporation, HDI isocyanurate variant having a functional number of 3.0), 0.5 parts of HI-299 (from Dainichiseika Color & Chemicals Mfg Co., Ltd., amine-based catalyst), and 10 parts of L7075 (from Dainippon Ink & Chemicals Inc., white pigment).

The resin composition was coated on the entire surface of full-dull release paper (from Lintec Corporation) using a knife overall coater. The resin on the release paper was dried by an air oven at 120° C. to form a non-porous film with a thickness of 10 μm.

Next, a binder resin solution was prepared to have the following composition.

100 parts of Y134-45 (from Dainichiseika Color & Chemicals Mfg Co., Ltd., second liquid-type polyurethane resin, solid part 60%), 30 parts of toluene, 40 parts of MEK, 9 parts of Coronate HL (from Nippon Polyurethane Industry Co., Ltd., isocyanate), and 0.5 parts of HI-299 (from Dainichiseika Color & Chemicals Mfg Co., Ltd., amine-based catalyst).

The resin solution was applied on the non-porous film in spots by a gravia coater and dried at 120° C., after which a porous polyurethane resin film (150 μm in thickness) of the polyester plain fabric (83 dtex in both lengthwise and widthwise yarns, 72 filament, lengthwise density X widthwise density: 111 pieces×90 pieces/2.54 cm, weight per unit area: 75 g/m²) was bonded to the non-porous film through the binder resin by heat press at 120° C. and 200 kPa, the porous polyurethane resin being provided on one side of the polyester plain fabric. Then, the resultant product was aged at 40° C. for 24 hours, followed by removing the release paper. Subsequently, the product was treated by water repelling using Asahi Guard AG5690 (from Asahi Glass Co., Ltd., fluorine-based water repellent agent) and finished at 150° C. for 30 seconds, thereby producing a moisture-permeable waterproof sheet.

### Comparative Example 5

Comparative Example 5 was prepared by the same process of Example 6 except for the elimination of 6 parts of Duranate TPA-100 (from Asahi Kasei Corporation, HDI isocyanurate variant having a functional number of 3.0) and 0.5 parts of HI-299 (from Dainichiseika Color & Chemicals Mfg Co., Ltd., amine-based catalyst), thereby producing a moisture-permeable waterproof sheet.

The evaluation results of the moisture-permeable waterproof sheets obtained in Example 6 and Comparative Example 5 were illustrated in Table 3.

TABLE 3

| | Example 6 | Comparative Example 5 |
|---|---|---|
| Polyurethane Resin | A-1 | A-1 |
| (OE-group Content) | (50%) | (50%) |
| Average Functional number of | 3.0 | No Cross-linker |
| Cross-linker | | |
| Moisture Permeability | 16,800 | 17,200 |
| [g/m² · 24 hours] | | |
| Water Resistance | 20,000 | 20,000 |
| [mm H₂O] | or more | or more |
| Water Resistance after | 20,000 | 4,100 |
| Insecticide Treatment | or more | |
| [mm H₂O] | | |

### Evaluation Results

As clearly illustrated in Tables 1 to 3, Examples 1 to 6 including the polyurethane resin compositions containing the hydrophilic polyurethane resin and organic polyisocyanate having a specific functional number are superior in all of moisture permeability, water resistance, water resistance after insecticide treatment, and water resistance after treatment with a DMF/ethanol solution. Among them, Examples (1 and 4) with a higher oxyethylene-group content tend to be slightly favorable in moisture permeability.

Meanwhile, Comparative Examples 1 and 3 not containing the hydrophilic polyurethane resin have low moisture permeability. Further, Comparative Examples 2, 4, and 5 not containing organic polyisocyanate having a specific functional number are low in water resistance after insecticide treatment, and Comparative Example 2 is low also in water resistance after treatment with a DMF/ethanol solution.

As described above, it is identified that the moisture-permeable waterproof sheets in Examples have excellent moisture permeability, waterproofness, and chemicals resistance.

### Example 7

### <Dry Laminating/Pattern>

A resin composition having a viscosity of 400 mPa·s specified as follows was prepared.

| | |
|---|---|
| A-1 | 80 parts |
| A-3 | 20 parts |
| Duranate | 8 parts (from Asahi Kasei Corporation, HDI |
| TPA-100 | isocyanurate variant having a functional number of 3.0) |
| HI-299 | 0.5 parts (from Dainichiseika Color & Chemicals |
| | Mfg Co., Ltd., amine-based catalyst) |
| L7075 | 2.5 parts (from Dainippon Ink & Chemicals Inc., |
| | white pigment) |

The resin composition was coated on the entire surface of full-dull release paper (from Lintec Corporation) using a knife overall coater. The resin on the release paper was dried by an air oven at 120° C. to form a non-porous film with a thickness of 10 μm.

Next, a binder resin solution was prepared to have the following composition.

| | |
|---|---|
| Y134-45 | 100 parts (from Dainichiseika Color & Chemicals |
| | Mfg Co., Ltd., two liquid-type polyurethane resin, |
| | solid part 60%) |
| Toluene | 30 parts |
| MEK | 40 parts |
| Coronate HL | 9 parts (from Nippon Polyurethane Industry Co., Ltd., |
| | isocyanate) |
| HI-299 | 0.5 parts (from Dainichiseika Color & Chemicals |
| | Mfg Co., Ltd., amine-based catalyst) |

The binder resin solution was applied on the non-porous film in spots by a gravia coater and dried at 120° C., after which polyester plain fabric (83 dtex in both lengthwise and widthwise yarns, 72 filament lengthwise density X widthwise density: 111 pieces×90 pieces/2.54 cm, weight per unit area: 75 g/m²) was bonded to the non-porous film through the binder resin by heat press at 120° C., the polyester plain fabric having been treated by water repelling using Asahi Guard AG710 (from Asahi Glass Co., Ltd., fluorine-based water repellent agent). Then, the resultant product was aged at 60° C. for 72 hours, followed by removing the release paper, thereby producing a moisture-permeable waterproof sheet having the non-porous layer on one side of fiber cloth.

Then, a resin solution for a pattern was prepared as follows:

| | |
|---|---|
| A-1 | 100 parts |
| Duranate | 8 parts (from Asahi Kasei Corporation, HDI |
| TPA-100 | isocyanurate variant having a functional number of 3.0) |
| HI-299 | 0.5 parts (from Dainichiseika Color & Chemicals |
| | Mfg Co., Ltd., amine-based catalyst) |
| HAULAC | 16 parts (from Dainippon Ink & Chemicals Inc., |
| Black A-1361 | black pigment) |
| HAULAC | 4 parts |
| White A-1004 | |

The resin solution was applied on the non-porous film in a spots by a gravia coater and dried at 120° C. to give a spot pattern on the entire surface of the non-porous film, thereby producing a moisture-permeable waterproof sheet.

The evaluation results of the moisture-permeable waterproof sheet were illustrated below.

| | |
|---|---|
| Polyurethane resin | A-1/A-3 |
| (OE-group Content) | 50%/0% |
| Average Functional number of Cross-linker | 3 |
| Moisture Permeability | 17,800 g/m² · 24 hours |
| Water Resistance | 20,000 mm H₂O or more |
| Water Resistance after Insecticide Treatment | 20,000 mm H₂O or more |

Gray small spots were formed on the entire surface of the film, which was excellent in view of design. Further, the pattern was not removed but remained after the insecticide treatment.

### INDUSTRIAL APPLICABILITY

The present invention can be applied to a moisture-permeable waterproof sheet having excellent moisture permeability and waterproofness, chemical resistance to chemicals such as insecticide and an organic solvent, and superior durability.

1. A polyurethane resin composition for a moisture-permeable waterproof sheet, comprising a hydrophilic polyurethane resin (A), organic polyisocyanate (B) having polyisocyanate (B0) with a functional number of 3 or more, and an organic solvent (C).

2. The polyurethane resin composition for a moisture-permeable waterproof sheet according to claim 1, wherein the hydrophilic polyurethane resin (A) is a polyurethane resin comprising high-molecular diol (d) containing an oxyethylene group, organic diisocyanate (e) and a chain extender (f), and a content of the oxyethylene group is 10 to 80 mass % with respect to the hydrophilic polyurethane resin (A).

3. The polyurethane resin composition for a moisture-permeable waterproof sheet according to claim 1, wherein the organic polyisocyanate (B) is at least one selected from the group consisting of aliphatic polyisocyanate and alicyclic polyisocyanate which have an average functional number of from 2.3 to 5.

4. A moisture-permeable waterproof sheet comprising a non-porous layer of a polyurethane resin formed by reacting the polyurethane resin composition according to claim 1, and at least one of fiber cloth and an open successive porous film.

5. The moisture-permeable waterproof sheet according to claim 4, wherein the non-porous layer is the outermost layer or a neighboring layer to the outermost layer.

6. The moisture-permeable waterproof sheet according to claim 4, wherein a pattern is formed on the non-porous layer by a resin film formed by reacting the polyurethane resin composition.

7. The moisture-permeable waterproof sheet according to claim 4, wherein the open successive porous film is a successive porous polytetrafluoroethylene film

8. The moisture-permeable waterproof sheet according to claim 4, wherein a water resistance according to JIS IL 1092, after a treatment with an organic solvent including at least one selected from N,N′-diethyl-m-toluamide and amide-based solvents, is 5,000 mmH₂O or more.

9. A method of manufacturing a moisture-permeable waterproof sheet, comprising applying a polyurethane resin composition which includes a hydrophilic polyurethane resin (A), organic polyisocyanate (B) having polyisocyanate (B0) with a functional number of 3 or more and an organic solvent (C), and has a viscosity of 1,000 to 30,000 mPa·s, to at least one side of fiber cloth and open successive porous film; and then drying the resultant coating, thereby forming a non-porous layer.

10. The method of manufacturing the moisture-permeable waterproof sheet according to claim 9, comprising bonding a fiber cloth to one side of the open successive porous film; applying the polyurethane resin composition having a viscosity of 1,000 to 30,000 mPa·s on the other side of the open successive porous film; and then drying the resultant coating, thereby forming a non-porous layer.

11. A method of manufacturing a moisture-permeable waterproof sheet, comprising applying a coating solution prepared from a polyurethane resin composition including a hydrophilic polyurethane resin (A), organic polyisocyanate (B) having polyisocyanate (B0) with a functional number of 3 or more and an organic solvent (C) to a release paper and drying the coating to form a non-porous film; providing a binder resin on the non-porous film to bond the non-porous film with fiber cloth and/or a successive porous film through the binder resin, and removing the release paper.

12. The method of manufacturing a moisture-permeable waterproof sheet according to claim 9, wherein the open successive porous film is a successive porous polytetrafluoroethylene film.
